(19) United States
(12) Patent Application Publication
(10) Pub. No.: US 2016/0378344 A1
(43) Pub. Date: Dec. 29, 2016

(54) PROCESSOR AND PLATFORM ASSISTED NVDIMM SOLUTION USING STANDARD DRAM AND CONSOLIDATED STORAGE

(71) Applicant: INTEL CORPORATION, Santa Clara, CA (US)

(72) Inventors: Murugasamy K. Nachimuthu, Beaverton, OR (US); Mohan J. Kumar, Aloha, OR (US); George Vergis, Portland, OR (US)

(73) Assignee: INTEL CORPORATION, Santa Clara, CA (US)

(21) Appl. No.: 14/748,798

(22) Filed: Jun. 24, 2015

(51) Int. Cl. G06F 3/06; G06F 12/08

(52) U.S. Cl. CPC G06F 3/065; G06F 3/061; G06F 3/0629; G06F 3/0685; G06F 12/0802; G06F 2212/1016

(57) ABSTRACT

Methods and apparatus for effecting a processor- and platform-assisted NVDIMM solution using standard DRAM and consolidated storage. The methods and apparatus enable selected data in DRAM devices, such as DIMMs to be automatically copied to a persistent storage device such as an SSD in response to detection of a power unavailable event or an operating system error or failure without any operating system intervention. In one aspect, a platform includes a power supply and a temporary power source, such as a capacitor-based energy storage device, a small battery, or a combination of the two, either integrated in the power supply or separate. When power becomes unavailable, the temporary power source is use to continue to provide power to selected components in one or more power protected domains. The energy stored in the temporary power source is sufficient to temporarily power the components to enable DRAM data to be written to the persistent storage device. Upon system restart, the previously-stored DRAM data is restored to one or more DRAM devices from which the data was originally copied.

### BACKGROUND INFORMATION

Memory is as ubiquitous to computing as the processors themselves, and is present in every computing device. There are generally two classes of memory—volatile memory, and non-volatile (NV) memory. The most common type of volatile memory is dynamic random access memory (DRAM), which is common component of substantially every computing device. Generally, DRAM may be implemented as a separate component that is external to a processor or it may be integrated on a processor, such as under a System On a Chip (SoC) architecture. For example, the most common type of packaging for DRAM in personal computers, laptops, notebooks, etc. are dual in-line memory modules (DIMM5) and single in-line memory modules (SIMMs). Meanwhile, smartphones and tables may employ processors with on-die DRAM or otherwise use one or more DRAM chips that are closely coupled to the processor using flip-chip packaging and the like.

During the early PC years, the computer's Basic Input and Output System (BIOS) was stored on a read-only memory (ROM) chip, which comprises one type of non-volatile memory. Some of these ROM chips were truly read-only, while others used Erasable Programmable ROM (EPROM) chips. Subsequently, “flash” memory, a type of Electrically Erasable Programmable ROM (EEPROM) technology was developed, and became a standard technology for NV memory. Whereas conventional EPROMS had to be completely erased before being rewritten, flash does not, thus providing far greater usability than EPROMs. In addition, flash provides several advantages over conventional EEPROMs, and as such EEPROMs are generally classifies as flash EEPROMs and non-flash EEPROMs.

There are two types of flash memory, which are names after NAND and NOR logic gates. NAND type flash memory may be written and read using blocks (or pages) of memory cells. NOR type flash memory allows a single byte to be written or read. Generally NAND flash is more common than NOR flash, and is used for such devices as USB flash drives (aka thumb drives), memory cards, and solid state drives (SSDs).

DRAMs typically have much higher performance than flash memory, including substantially faster read and write access. They are also substantially more expensive than flash on a per memory unit basis. A major drawback of DRAM technology is that it requires power to store the cell data. Once power is removed, the DRAM cells soon lose its ability to store data. An advantage of flash technology is that it can store data when power is removed. However, flash is significantly slower than DRAM, and a given flash cell can only be erased and rewritten to a finite number of times, such as 100,000 erase cycles.

In recent years, a hybrid memory module has been introduced called an NVDIMM. The NVDIMM supports both the advantage of DRAM technology for fast read and write access, with the non-volatile feature of NAND memory. As shown in FIG. 1, this is typically accomplished by mounting one or more DRAM devices 100 (e.g., memory chips) on one side of a DIMM 102, and one or more NAND devices 104 and a custom Field-programmable Gate Array (FPGA) 106 or an Application-Specific Integrated Circuit (ASIC) (not shown) on the other side of the DIMM. The NVDIMM is connected with a “Super” capacitor via a super capacitor connector 108, which acts as temporary power source on DIMM power failure. When the system power goes down, the data residing in DRAM are written to NAND memory and is subsequently restored back to DRAM during the memory initialization of the next boot.

The FIG. 2 shows a computer system 200 with a processor 202 including a central processing unit (CPU) 204, two integrated Memory Controllers (iMCs) 206 and 208, and an integrated Input-Output (IIO) interface 210 to which multiple PCIe (Peripheral Component Interconnect Express) links 211 are coupled. iMC 206 is used to control access to a pair of DRAM DIMMs 212 and 214 via respective links 216 and 218 also labeled as Ch(annel) 1 and Ch(annel) 2. iMC 208 is used to control access to a pair of NVDIMMs 220 and 222 via respective links 224 and 226. NVDIMM 220 is attached to a super capacitor 228, while NVDIMM 222 is attached to a super capacitor 230. Each of super capacitors 228 and 230 is charged during platform power up and supplies power to its respective NVDIMM 220 and 222 on power failure. When the power failure detected, FPGA 106 detects the power failure and copies the DRAM 100 contents to NAND 104 for each of NVDIMMs 220 and 222. During the platform power on, after MRC initializes the DRAM, MRC requests FPGA 106 to restore the DRAM contents from NAND 104.

There are several drawback with this solution. Since a typical NVDIMM has DRAM devices on the one side and NAND devices and FPGA or ASIC for storing DRAM contents on the other side. Hence the total DIMM memory size is reduced due to real-estate occupied by the NAND and FPGA/ASIC. As mentioned above, upon power failure the DRAM data is written to NAND and then subsequently written back to DRAM. To ensure signal integrity and power efficiency (referred to as hot spots), address/data scrambling seeds are used. However, the address/data scrambling seeds may change between boots to avoid malicious programs from deterministically causing bus efficiency. As a result NVDIMMs typically use a mode under which address/data scrambling is disabled, leading to hot spot or more errors in the memory subsystem.

The technology for NAND device management is generally very rudimentary, which result in low quality RAS (Reliability, Availability, and Serviceability). When a DRAM or NAND device fails, the whole NVDIMM needs to be replaced. There are no standards defining the super capacitor size, placement, charge time, etc., resulting is different platform solutions. Also, there is no consistent command set, which results in different Memory Reference Code (MRC) support. Overall, the cost of the NVDIMM solution that exists today is 3× to 4× cost of a similar size DRAM DIMM. Moreover, data stored on the NVDIMM are not protected, hence moving an NVDIMM from one system to another may enable access to possibly sensitive data stored on the NVDIMM.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating the front-side and back-side of a conventional NVDIMM;

FIG. 2 is a schematic diagram of an existing NVDIMM solution using a pair of super capacitors;

FIGS. 3a and 3b are schematic diagrams of a first system for implementing an NVDIMM solution using conventional DRAM DIMMs and a persistent storage device, according to one embodiment under which a super capacitor is implemented in a power supply, wherein FIG. 3a depicts the system under normal power operation, and FIG. 3b depicts the power protected domain components that are powered via the super capacitor when the AC power input is removed from the power supply;

FIGS. 4a and 4b are schematic diagrams of a second system for implementing an NVDIMM solution using conventional DRAM DIMMs and a persistent storage device, according to one embodiment in which the super capacitor is separate from the power supply, wherein FIG. 4a depicts the system under normal power operation, and FIG. 4b depicts the power protected domain components that are powered via the super capacitor when the AC power input is removed from the power supply;

FIGS. 5a and 5b depict details of one embodiment of a processor, wherein FIG. 5a depicts the processor when operating under normal power input, and FIG. 5b depicts a condition under which input AC power to the power supply has failed or is otherwise unavailable;

FIG. 5c a processor that is configured to work with the system of FIGS. 4a and 4b, under which the processor includes separate power input pins that are supplied with input power via a super capacitor and power conditioning circuitry;

FIG. 6 is a flowchart illustrating operations and logic performed during a power on process for a platform that stores DRAM content to a persistent backing store device, according to one embodiment;

FIG. 7 is a flowchart illustrating operations performed during a platform power failure or power down, according to one embodiment;

FIG. 7a is a flowchart illustrating operations performed in response to an operating system failure or error, according to one embodiment;

FIG. 8a shows a multi-socket platform including two nodes that are each configured to back up persistent DRAM data to a persistent storage device for the node, according to one embodiment;

FIG. 8b shows an implementation of the multi-socket platform of FIG. 8a under which DRAM data from both nodes are copied to a persistent storage device on one of the nodes;

FIG. 9 is block schematic diagram showing details of the internal architectures of a pair of processors when installed in sockets 2 and 3 of a 4-socket computer platform, according to one embodiment; and

FIG. 10 is a schematic diagram of a system that employs an SMI and one or more SMM handlers to flush data in cache to DRAM and to copy persistent DRAM to a persistent storage device, according to one embodiment.

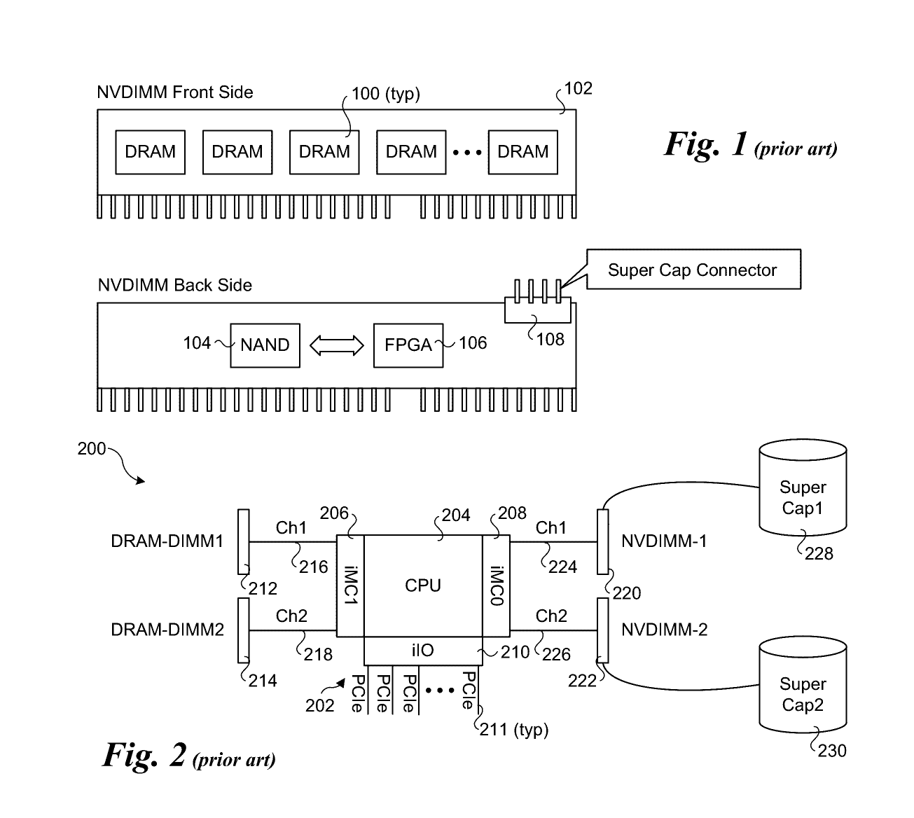

### DETAILED DESCRIPTION

Embodiments of methods and apparatus for effecting a processor- and platform-assisted NVDIMM solution using standard DRAM and consolidated storage are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

As used herein, the term SSD (Solid State Disk) is used to describe a type of persistent storage device, such as but not limited to a PCIe SSD, a SATA (Serial Advanced Technology Attachment) SDD, a USB (Universal Serial Bus) SSD, a memory device (MD), or any other type of storage device that can store the data in a reasonable amount of time. This may also include network- and fibre channel-based storage. By way of example and without limitation, embodiments herein are illustrated using PCIe interconnects and interfaces. However, the use of PCIe is merely exemplary, as other types of interconnects and interfaces may be used, generally including any memory or storage link such as but not limited to DDR3, DDR4, DDR-T, PCIe, SATA, USB, network, etc.

In accordance with aspects of the embodiments now described, a non-volatile power-failure (or power unavailable) memory retention mechanism is provided that addresses the deficiencies associated with NVDIMMs, as described in the Background Section. In brief, the mechanism employs a persistent storage device such as an SSD to back up selected data (or all data) on DRAM DIMMs (or other DRAM devices) upon detection of a power failure/power unavailable condition or operating system error/failure, and restores the DRAM data from the persistent storage device during a subsequent system initialization. Under an embodiment of the solution, DRAM DIMMs, memory controllers, an IO link that links a processor in communication with the persistent storage device and a DMA (Direct Memory Access) engine (memory copy engine) are power protected, such that they are provided with temporary power in the event of a power failure or power unavailable condition. In one embodiment, when the platform power fails/becomes unavailable, the DMA engine detects the condition and reads the DRAM contents from the DRAM DIMMS and writes the data to the persistent storage device. During platform power on, BIOS and/or firmware (FW) reads the data that was stored on the persistent storage device and restores the data to the DRAM (including any uncorrected memory errors).

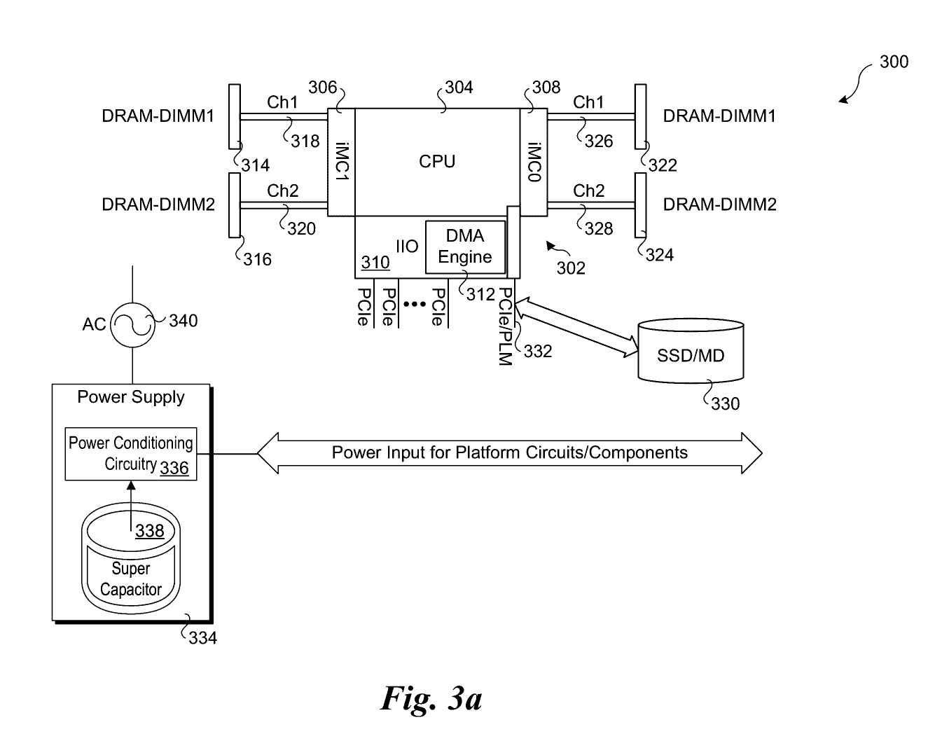

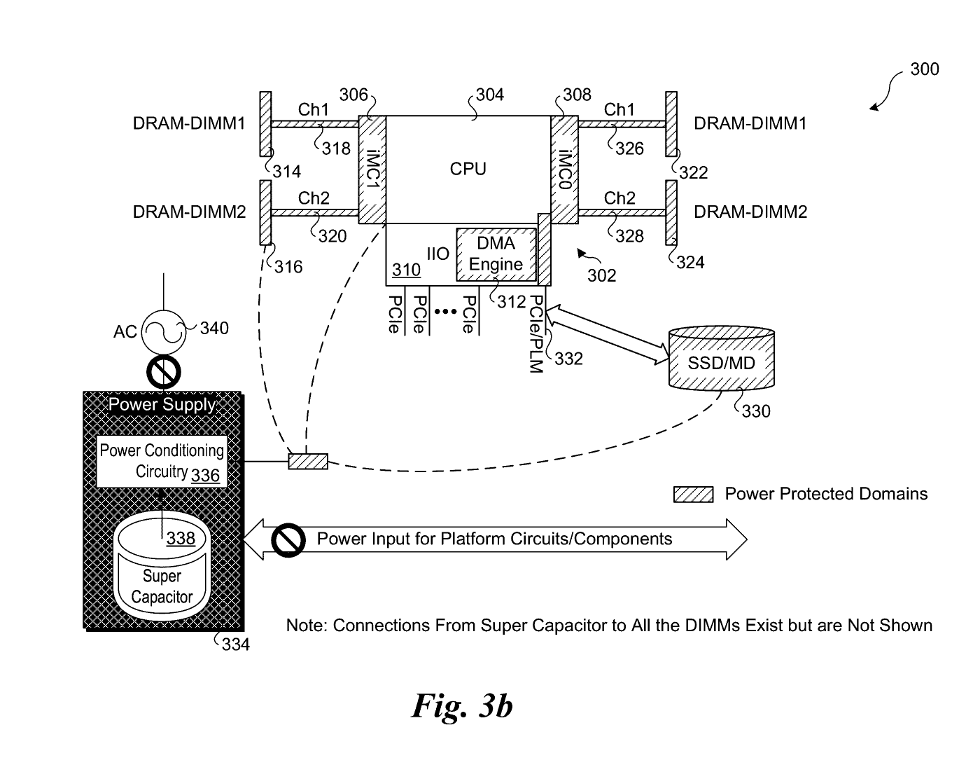

FIGS. 3a and 3b shows selected components of system 300 for implementing the solution, according to one embodiment. System 300 includes a processor 302 comprising a CPU 304, two iMCs 306 and 308, and an IIO interface 310 including a DMA engine 312. iMC 306 is used to control access to a pair of DRAM DIMMs 314 and 316 via respective iMC-to-DRAM DIMM links 318 and 320. iMC 308 is used to control access to a pair of DRAM DIMMs 322 and 324 via respective iMC-to-DRAM DIMM links 326 and 328. A storage device 330 comprising an SSD or MD is communicatively coupled to IIO interface 310 via a PCIe (if SSD) or a memory device (if MD) link 332.

System 300 further comprises a power supply 334 that includes power conditioning circuitry 336 and a super capacitor 338. In the illustrated embodiment, power supply 334 receives input power from an AC (alternating current) source 340; optionally, the input power may be received from a battery. Power conditioning circuitry, which is common to most power supplies, is used to provide one or more stable and clean voltage outputs, which are coupled via circuitry and/or wiring on the computer platform to provide voltage inputs at suitable DC (direct current) voltages to various components on the computer platform, such as depicted in the Figures herein. Additional circuitry (not separately shown) is typically used to convert AC input to a DC output and to step-down the voltage from 120 VAC or another AC input voltage, as is well-known in the art.

During normal operation, power supply 334 supplies suitable DC voltages to power the various platform circuitry and components. Upon removal of AC source 340 or a battery source, a power supply would normally cease providing power to the platform circuitry and components. However, power supply 334 is configured to charge super capacitor 338 during normal operations such that the energy stored in the super capacitor can be used to temporarily supply power to selected components and circuitry on the platform in the event that input power from AC source 340 or a battery source is removed, as shown in FIG. 3b. In the illustrated embodiment, the input DC voltages are provided as one or more outputs from power conditioning circuitry 336. However, this is merely an exemplary configuration and not limiting, as other power conditioning circuitry may be employed that is either included in power supply 334 or elsewhere on the platform.

In addition to capacitor-based energy storage devices, other types of temporary energy storage devices may be utilized, or the combination of different types of temporary energy storage devices may be utilized. For example, a small battery can be used in place of the super capacitors shown in the Figures herein, as a temporary power source that is able to supply sufficient power to enable applicable data to be copied from DRAM to persistent storage. Alternatively, a combination of a capacitor-based energy storage device and a battery may be used.

As further shown in FIG. 3b, one or more outputs of power conditioning circuitry 336 is coupled (either directly or via additional circuitry that is not shown) to each of DRAM DIMMs 314, 316, 322, and 324, iMCs 306 and 308, the iMC to DIMM links 318, 320, 326 and 328, DMA engine 312, PCIe/PLM link 332, and storage device 330. As will be discussed and illustrated below in further detail, the input power to each of these components may be provided as a direct input, or may be distributed and/or controlled through other circuitry that is not shown in FIG. 3b for simplicity and clarity. As designated by the cross-hatch pattern, each of DRAM DIMMs 314, 316, 322, and 324, iMCs 306 and 308, the iMC to DIMM links 318, 320, 326 and 328, DMA engine 312, PCIe/PLM link 332, and storage device 330 are members of power protected domains.

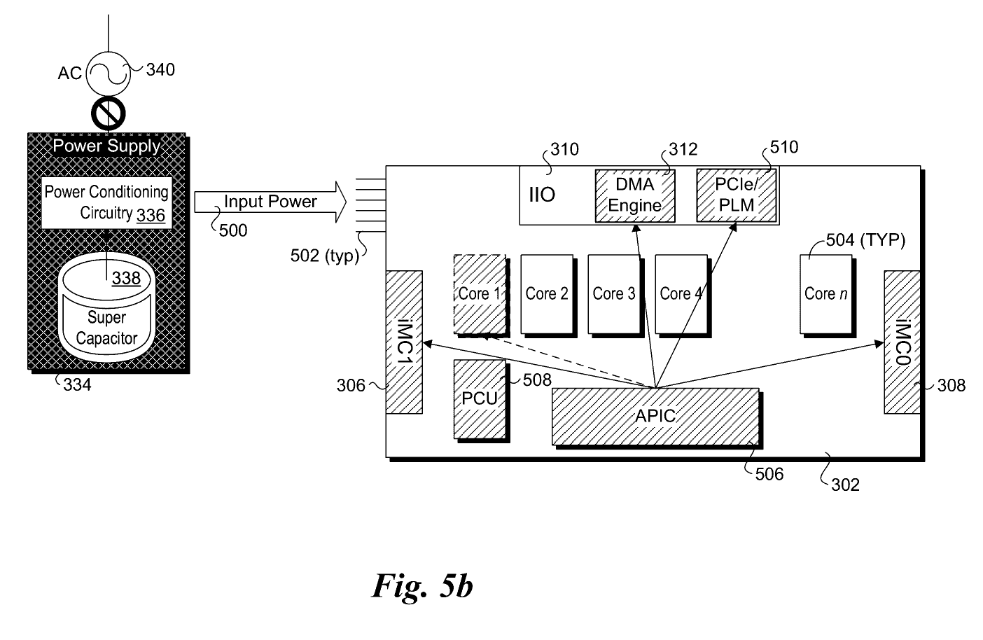

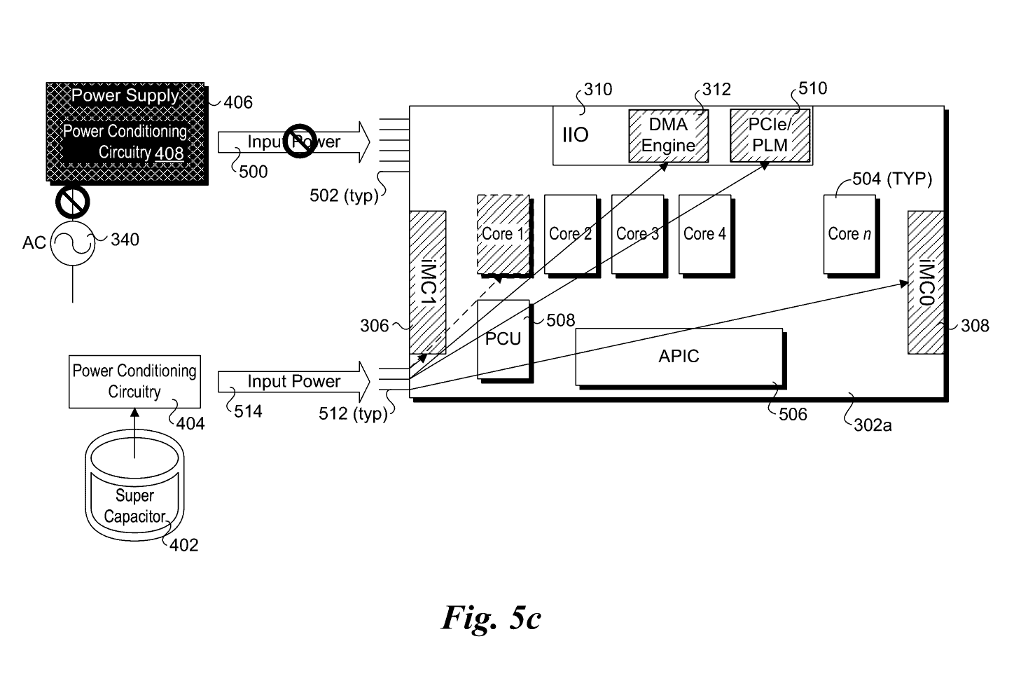

Generally, the power protection domain(s) for a system or platform will include the DRAM devices, iMC(s), IO link(s) that are connected to the persistent storage device(s), SSD(s) (or other type of persistent storage device), and the DMA engine, which may be implemente as hardware, or a combination of hardware and firmware. In addition, one or more microcontrollers (not shown) may be included in a power protection domain if the microcontroller(s) are used in assisting with programming the DMA engine to copy the data from DRAM to the storage device(s). Typically, the iMC, PCIe link interface and DMA engine are integrated inside a processor socket. As discussed below with reference to FIGS. 5a, 5b, and 5c, the processor socket can receive power from a protected power domain source as a power separate input and can power the iMC/PCIe/IIO/DMA engine logic using this power when the normal processor socket power failure is detected. Power for the power protected domain is supplied by a power source such as super capacitor or battery/UPS (Uninterruptable Power Supply) (not shown). Optionally, logic on-board the processor itself, such as an APIC logic block, a microcontroller and/or power control unit (PCU) may be configured to selectively power specific components.

In one embodiment, when the platform power fails or is otherwise removed (e.g., in connection with a planned platform shutdown), the power protected domains are still powered through super capacitor 338 and power conditioning circuitry 336. Generally, super capacitors will be selected based on the total power required to save applicable DRAM contents to the persistent storage device(s) within a reasonable period of time (e.g., approximately 30 seconds to 2 minutes). In one embodiment, the iMC-to-DRAM DIMM links are operational in power protected domain until the DMA engine has completed copying the configured DRAM memory contents to the persistent storage device (e.g. SSD). Similarly, the IO link(s) (e.g., PCIe link(s)) between the IIO and the SSD(s) are operational in the power protected domain until the DMA engine has completed copying the DRAM contents to the SSD(s).

As an option, a selected portion of the DRAM may be stored. For example, if the system has 64 GB of DRAM and the user is interested in making only 32 GB of DRAM to be persistent and use the other 32 GB for stack and temporary store, there is no need to copy all the DRAM data to the SSD. In this case, the user could tell the system BIOS through a setup option (or a platform could hard-code this option) to select how much amount of the DRAM memory to be made persistent. Based on the size selection, the BIOS could optimally select particular DRAMs to be power protected and store only selected region of the DRAM memory to SSD and restore them back on the next boot. This allows the storage (SSD) capacity to be selected based on the DRAM persistent needed rather than populating SSD capacity to cover the total DRAM size in the system.

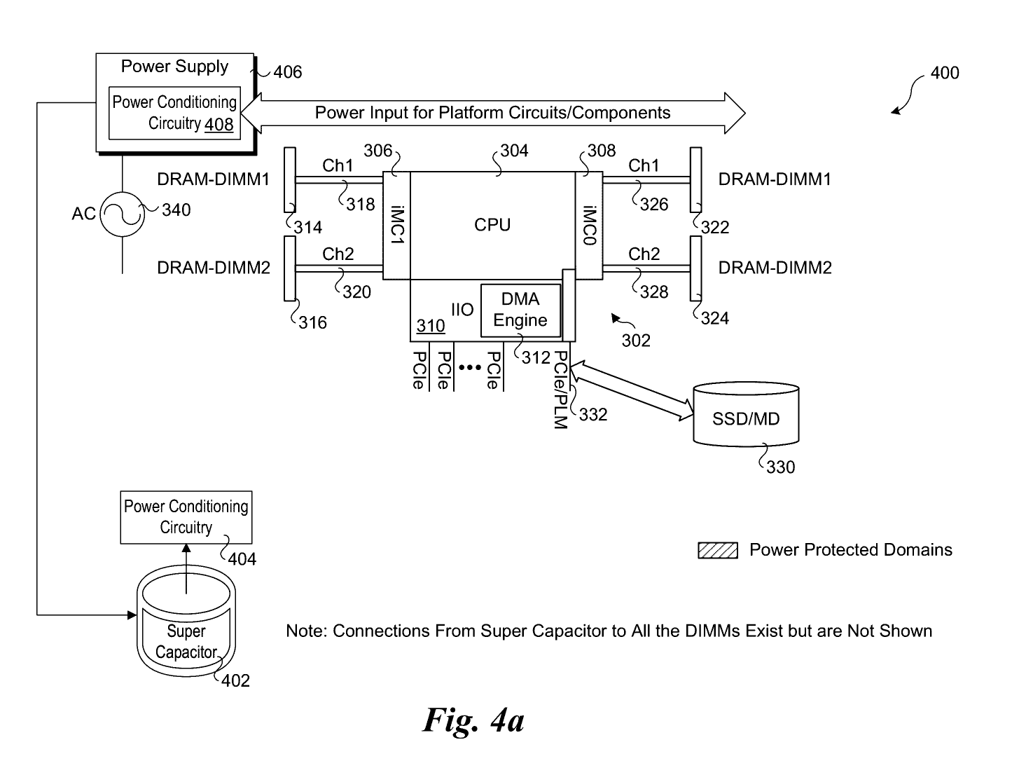

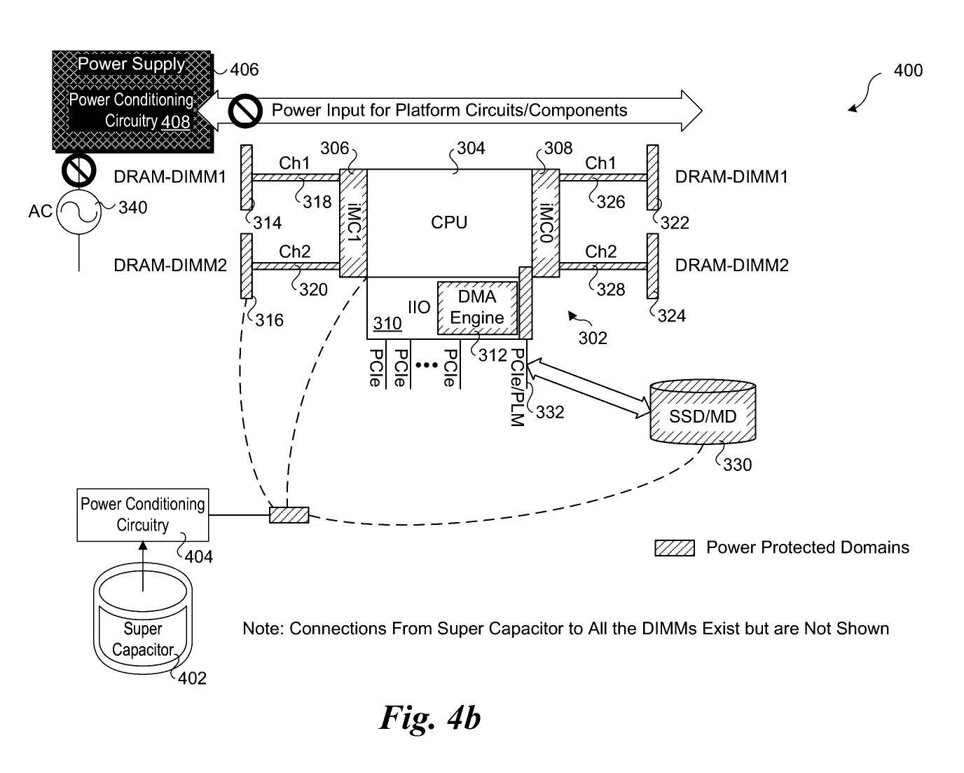

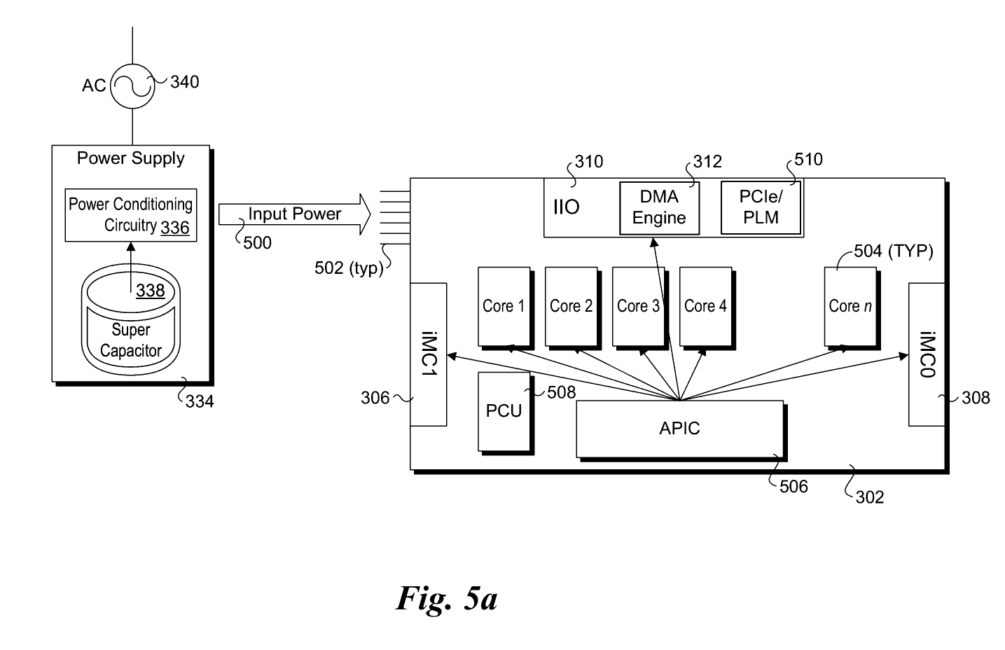

FIGS. 4a and 4b illustrate a system 400 under which a super capacitor 402 and power conditioning circuitry 404 are separate from a power supply 406 including power conditioning circuitry 408. Under the normal operation configuration of FIG. 4a, power supply 406 supplies power to the various platform components and circuitry in a manner similar to power supply 334 of FIGS. 3a and 3b. In addition, in the illustrated embodiment, power supply 406 provides an input DC voltage to super capacitor 402. In one embodiment, power conditioning circuitry 404 provides one or more isolated output that are shut off during normal operation (that is, when power supply 406 is receiving input from AC power source 340). Optionally, the output out of power supply circuitry 408 and 404 may be coupled via applicable circuitry or otherwise received by components and/or circuitry that is configured to provide power received by power conditioning circuitry 408 and/or power conditioning circuitry 404, depending on the operating state of the platform.

FIG. 4b shows a configuration under which AC power source 340 has failed or otherwise the input power source to power supply 406 has been removed. Under this configuration, super capacitor 402 provides input power (via power conditioning circuitry 404) to selected components in protected power domains, such as depicted by DRAM DIMMs 314, 316, 322, and 324, iMCs 306 and 308, the iMC-to-DRAM DIMM links 318, 320, 326 and 328, DMA engine 312, PCIe/PLM link 332, and persistent storage device 330.

FIGS. 5a, and 5b show further details of configurations for processor 302, according to one embodiment. As shown in FIG. 5a, input power 500 provided by power supply 334 during normal operating conditions is received at multiple power input pins 502 on processor 302. In the illustrated embodiment, processor 302 employs a System on a Chip (SoC) architecture, which includes a plurality of cores 504, an APIC block 506, and a PCU 508, in addition to iMCIs 306 and 308 and IIO 310. APIC block 506 manages of the interrupt subsystem of processor 302, while power input to various logic blocks and circuitry on processor 302 is provided by PCU 508. For example, modern processors have the ability to reduce power to selected logic blocks and/or circuitry, such as putting one or more of cores 504 in a reduced power mode or state.

FIG. 5b shows a configuration under which AC power source 340 has failed or otherwise has been removed or is unavailable. In response to detecting such an event, power conditioning circuitry 336 is configured to switch its power input to super capacitor 338, and continues to provide power to processor 302 via power input pins 502. However, logic in PCU 508 is configured to selectively power iMCs 306 and 308, DMA engine 312, and a PCIe/PLM interface 510 upon detection of a condition under which power input from power supply 406 is unavailable.

FIG. 5c shows a processor 302athat is configured to work with system 400 of FIGS. 4a and 4b. Under this configuration, processor 302a includes separate power input pins 512 that are supplied with input power 514 via super capacitor 402 and power conditioning circuitry 404. In the illustrated embodiment, various pins among power input pins 512 are internally connected (within processor 302a) to each of iMCs 306 and 308, DMA engine 312, and PCIe/PLM interface 510. Optionally, one or more of cores 504 may receive power via power input pins 512. As an option, all or a portion of the separate power input pins 512 may be coupled to PCU 508, which in turn may be coupled to one or more of iMCs 306 and 308, DMA engine 312, and PCIe/PLM interface 510.

In one embodiment, the DMA engine detects the socket power failure condition and starts to read the local socket DIMMs contents and stores (via DMA writes) to the power protected SSD(s). Today, the socket Source Address Decoders (SAD, aka DRAM rules) allows memory interleave between sockets. However, on power failure condition, in one embodiment it implements a mode where the entire DRAM contents can be accessed by the DMA engine.

The DRAM memory ranges may be further classified as volatile and persistent memory regions. In one embodiment, only persistent memory region(s) need to be stored to the persistent storage device (e.g., SSD) on power failure or power removal. This reduces the SSD size requirement and the power/time required to save/restore data to and from the SSD. In one embodiment, the DMA engine stores meta-data such as DRAM sizes, DRAM population location information, DRAM interleave, etc. for the system memory configuration to be re-constructed in a subsequent platform initialization operations.

In one embodiment, the DMA engine copies the entire DRAM memory contents including the uncorrected memory error conditions to the SSD. In one embodiment the DMA engine may include additional encryption features to encrypt the data that it is writing to the SSD. For example, the data may be encrypted based on platform specific TPM (Trusted Platform Module) keys if the data has to be tied to specific platform. Optionally, the SSD security features such as passphrase may be enabled if the data written to the DRAM has to be protected from unauthorized user.

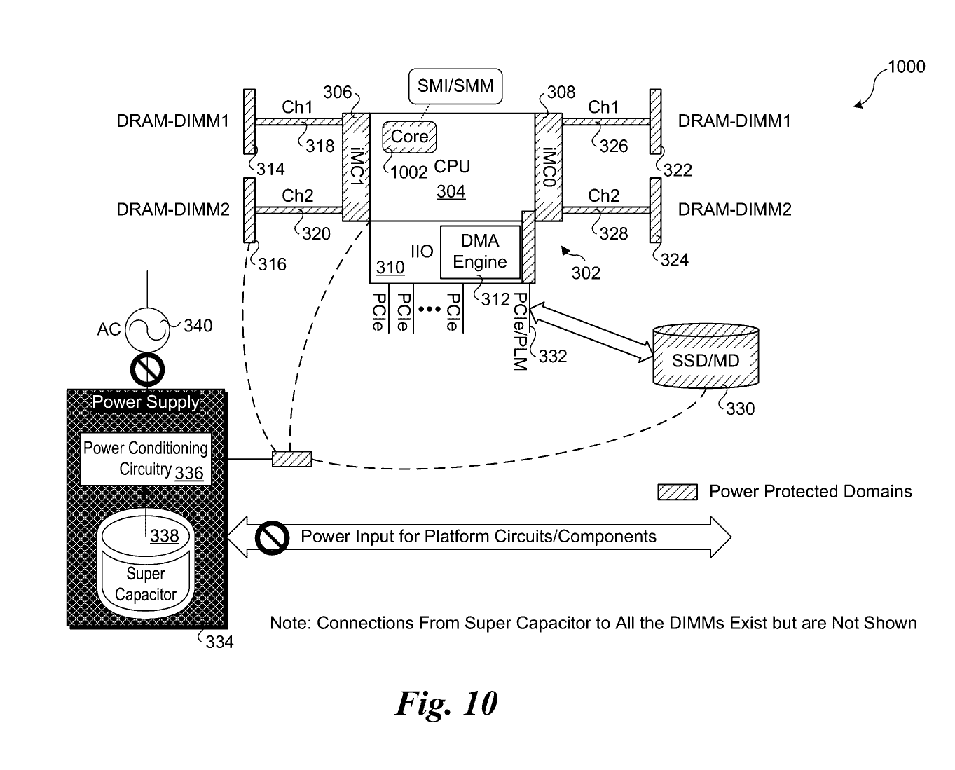

In a variation of the foregoing process, in one embodiment in response to detection of a power failure/unavailable condition, an SMI (System Management Interrupt) is signaled for BIOS to flush all the processor cache(s) and then send a signal to the DMA engine to enter the power fail mode to save the DRAM content to SSD. Further details of the use of SMI are described below with reference to FIG. 10.

When the platform is rebooted, the platform BIOS/FW initializes the DIMMs and SSD and detects the stored memory images and meta-data and restores them to the DIMM(s). In one embodiment, the SSD is partitioned into a persistent DRAM save area and normal OS use area to allow un-used DRAM backing capacity that may be used for the OS. The DRAM backing SSD partition may have a separate passphrase than the one used for the normal OS partition. In one embodiment, the DMA engine and BIOS is responsible for managing the DRAM backing SSD partition passphrase for additional security.

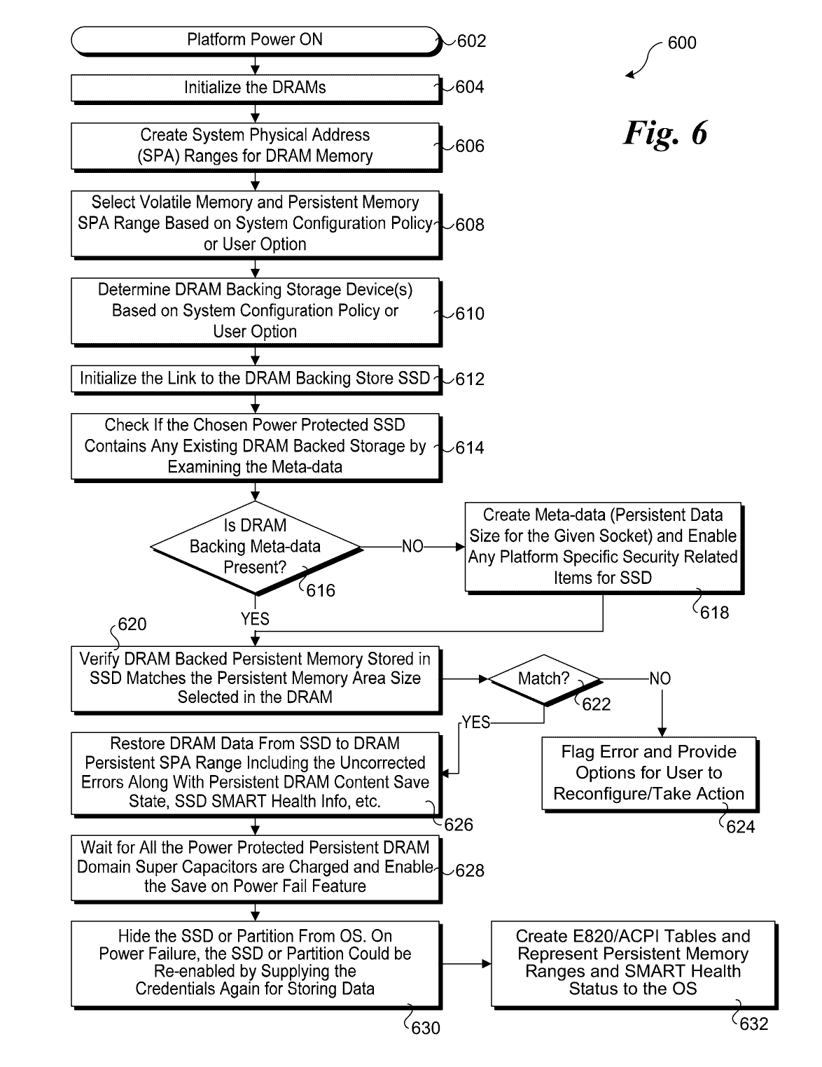

FIG. 6 shows a flowchart 600 illustrating operations and logic performed during a power on process for a platform that stores DRAM content to a persistent backing store device (e.g., an SSD), according to one embodiment. In the following description it is presumed that the persistent (i.e., non-volatile) memory is not interleaved across sockets and there is a DRAM backing store available per socket.

The process begins in a start block 602 under which the platform is powered on. In a block 604 the DRAMs are initialized in the conventional manner. Next, in a block 606 system physical address (SPA) ranges are created for DRAM memory. One or more volatile memory and persistent memory SPA ranges are selected in a block 608, based on a system configuration policy or as a user option. For example, a specific power protection PCIe or PLM link or a specific SSD selection may be employed for this operation. The DRAM backing storage device(s) is/are then determined in a block 610 based on the system configuration policy or user option, as applicable.

In a block 612 the IO link to the persistent DRAM backing storage device (e.g., SSD) is initialized. In a block 614 the chosen power protected SSD is checked to see if it contains any existing DRAM backed storage by examining the meta-data. For example, the meta-data could be on a specific partition with a platform passphrase to a specific LBA (logical block address) region or to a specific file, or to a specific volume.

In a decision block 616 a determination is made to whether there is any DRAM backing meta-data present. If the answer is NO, the logic proceeds to a block 618 in which applicable meta-data is created, and any applicable platform-specific security related items for the SDD are enabled. For example, the meta-data may include a persistent data size to be implemented for a given socket.

If the answer to decision block 616 is YES, or after the operations of block 618 are performed, the logic proceeds to a block 620 in which the DRAM backed persistent memory stored in the SSD matches the persistent memory areas size selected in the DRAM. As depicted by a decision block 622, if there is not a match, the answer to decision block 622 is NO, and the logic proceeds to a block 624 in which an error is flagged and the user is provided with options for reconfiguring the platform and/or taking other actions. If there is a match, the answer to decision block 622 is YES, and the logic proceeds to a block 626 in which the DRAM data stored in the SSD is restored to the DRAM persistent SPA range(s) including the uncorrected errors along with the persistent DRAM content save state, SSD SMART health information, etc.

Next, in a block 628 the platform waits until (all) the power protected persistent DRAM super capacitor(s) is/are charged and enables the save on power failure feature. In a block 630 the SSD or power protected persistent partition on the SSD is hidden from the operating system. On a power failure, the SSD or partition could be re-enabled by supplying the credentials again for storing data. The process is completed in a block 632 in which the E820/ACPI tables are created and the persistent memory ranges and SMART health status is presented to the operating system.

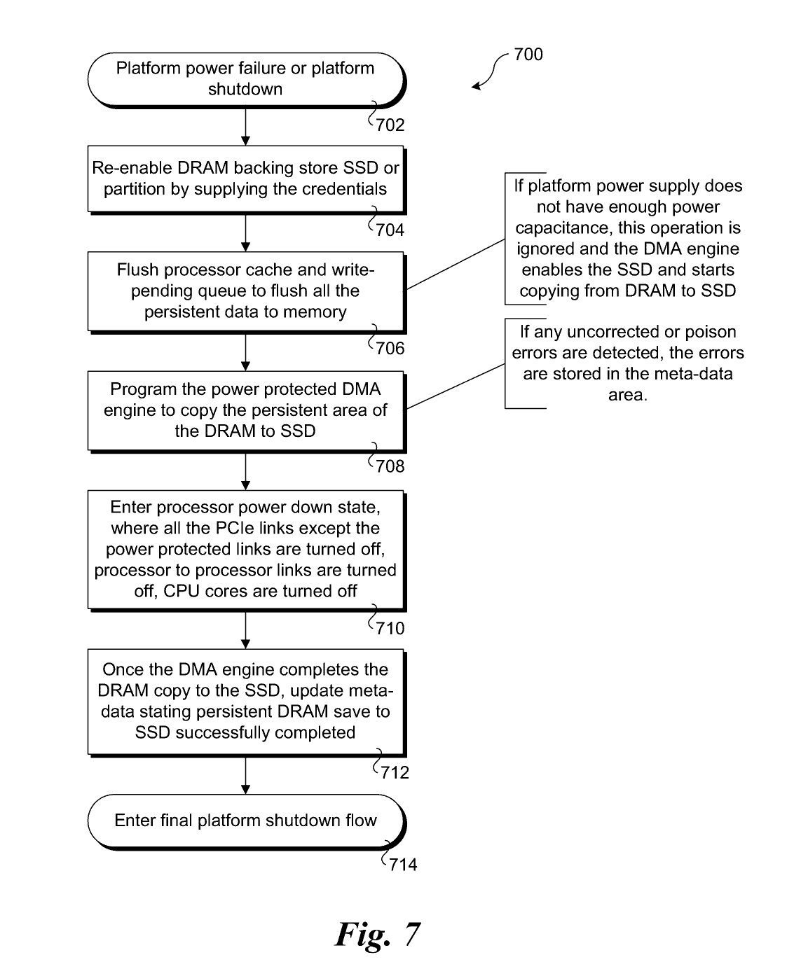

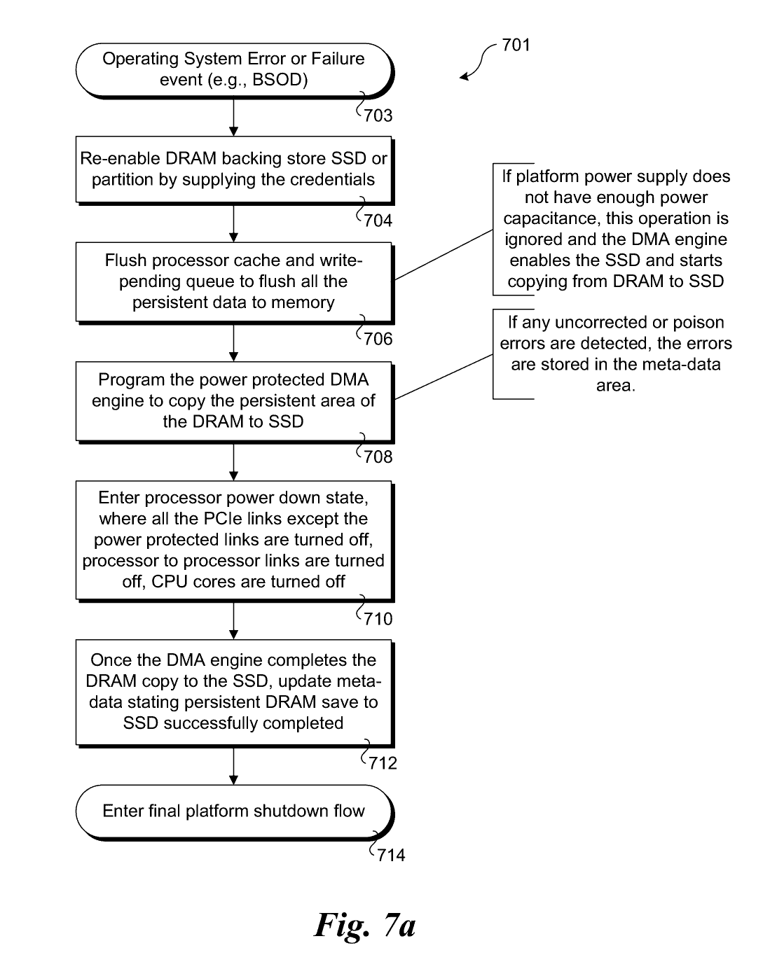

FIG. 7 shows a flowchart 700 illustrating operations performed during a platform power failure or power down, according to one embodiment. The process flow begins in a start block 702 in which the platform power failure or platform shutdown occurs. In a block 704 the DRAM backing store SSD or partitions is re-enabled by supplying the proper credentials. In a block 706 the processor cache(s) and the write-pending queue are flushed to flush all of the persistent data (in the cache(s) and write-pending queues to memory (DRAM). If the platform power supply does not have enough capacitance, this operation is ignored and the DMA engine enables the SSD and starts copying data from DRAM to the SSD.

In a block 708 the power protected DMA engine is programmed to copy the persistent area of the DRAM to the SSD. In any uncorrected or poison errors are detected, the errors are stored in the meta-data area. In a block 710, the processor enters a power down state, where all of the PCIe links expect the power protected links are turned off, processor to processor links (e.g., socket-to-socket links) are turned off, and the CPU cores are turned off. Once the DMA engine completes the DRAM copy to the SSD, the meta-data is updated to state the persistent DRAM save to SSD operation has been successfully completed, as depicted in a block 714. The process is completed in an end block 714 in which the final platform shutdown flow is entered

If the platform power supply plus super capacitor has enough power, all the PCIe links except the DRAM backing PCIe link could be turned off and the BIOS can start the DMA engine to start coping the DRAM data to SSD and make all the CPU cores enter low power state.

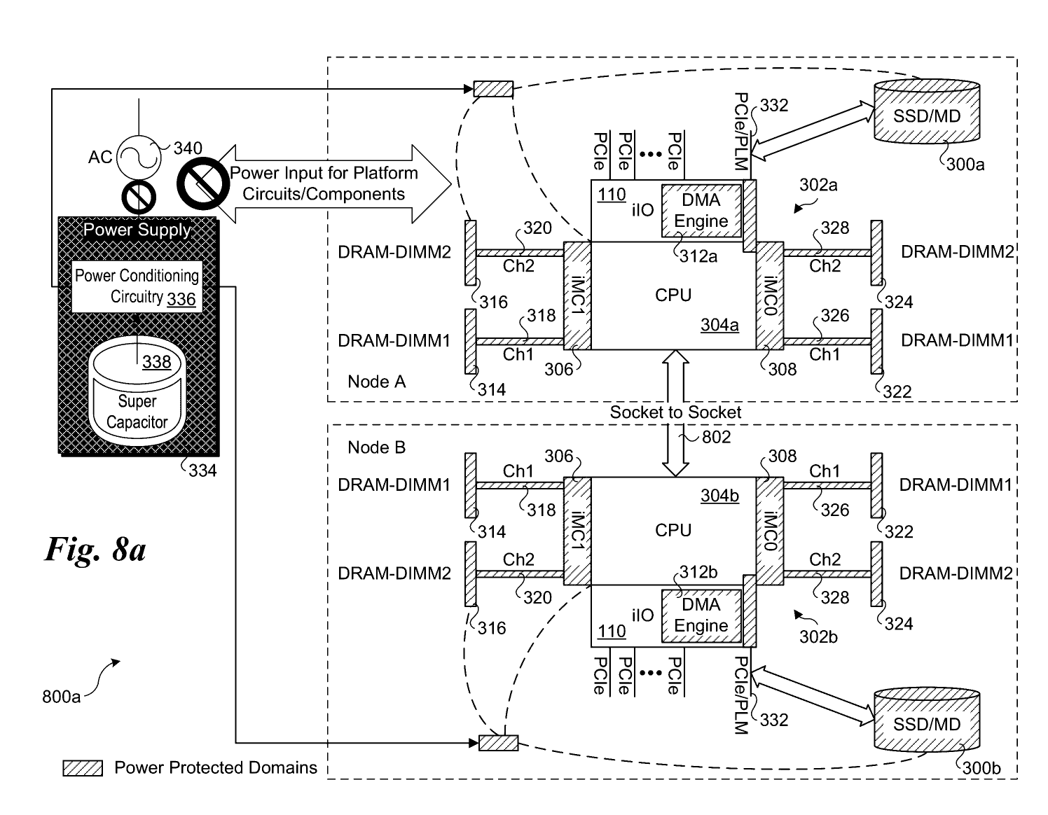

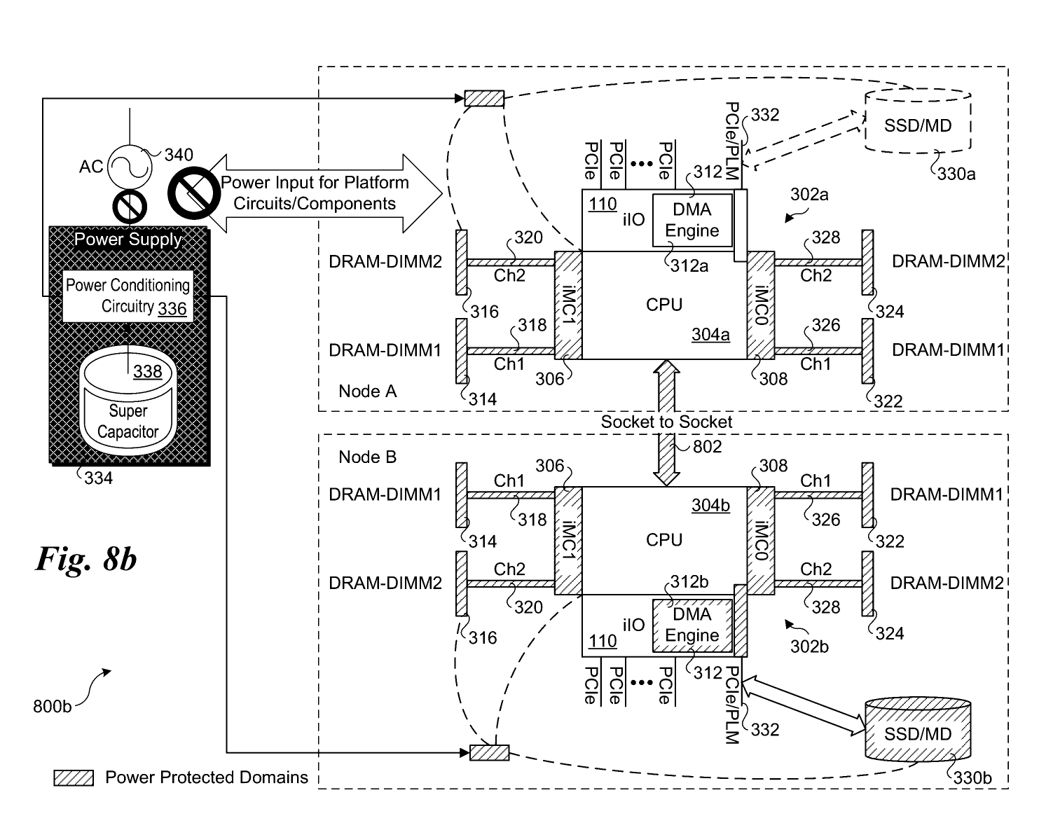

FIGS. 8a and 8b respectively illustrate exemplary multi-socket systems 800a and 800b that include power protected domains and are configured to automatically store DRAM data to persistent storage and then restore the DRAM data upon a subsequent boot operation. Components in FIGS. 8a and 8b with like-numbered reference numbers to those shown in earlier Figures perform similar functions.

Multi-socket system 800a includes a pair of nodes (sockets) A and B, each with a similar configuration to that shown in FIGS. 3b and 4b. Processors 302a and 302b are linked in communication via a socket-to-socket interconnect 802. Each of nodes A and B receive power inputs from power supply 334, which supplies power to the components and circuitry for each node. Generally, each of nodes A and B operate independently and include complete facilities for storing DRAM data to respective persistent storage devices 330a and 330b. For example, in response to a power failure or power source removal event, logic in node A including DMA engine 312a will copy applicable DRAM data in node A's DRAM DIMMS to persistent storage device 300a, while similar logic in node B including DMA engine 312b will copy applicable DRAM data stored in one or more of node B's DRAM DIMMs to persistent storage device 300b. The memory restore operations for each of nodes A and B are similar to those described above in flowchart 600.

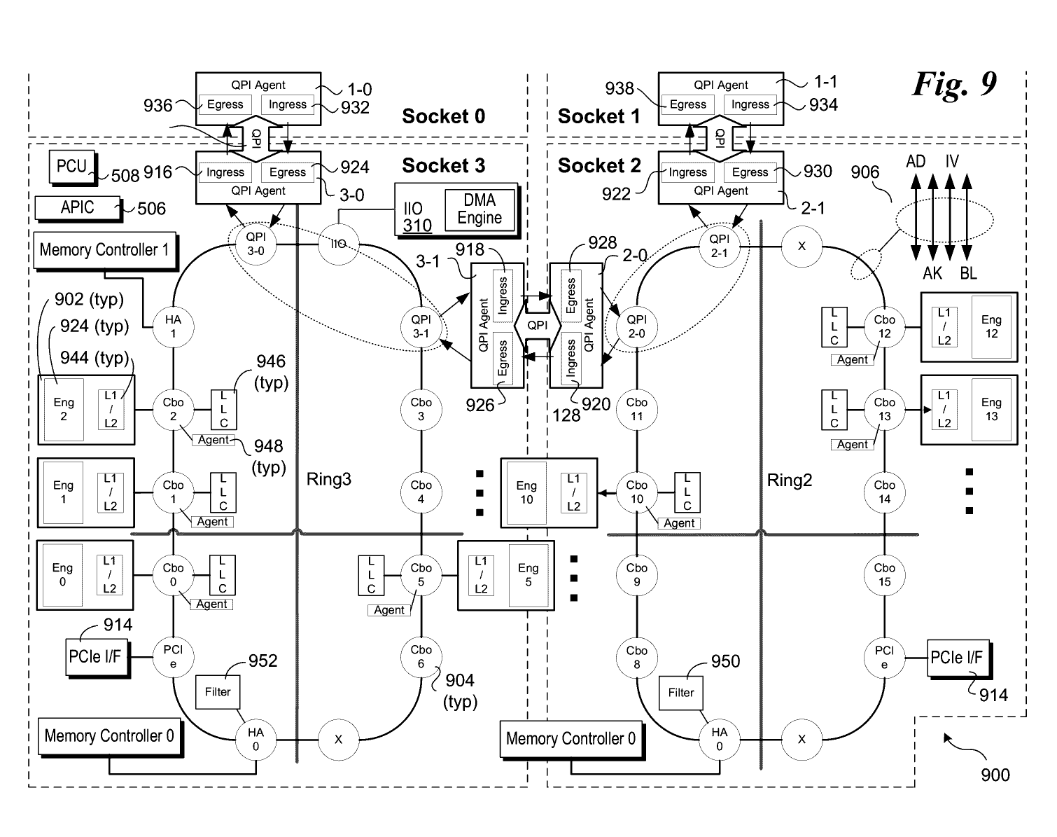

Under system 800b of FIG. 8b, DRAM data on both nodes A and B is copied to persistent storage device 330b on node B. This is facilitated, in part, via socket-to-socket interconnect 802, which has now been added to the protected power domain. In one embodiment, socket-to-socket interconnect 802 comprises a QuickPath Interconnect (QPI) link. In another embodiment, socket-to-socket interconnect 802 comprises a Keizer Technology Interconnect (KTI) link. More generally, any existing a future socket-to-socket interconnect may be used. Under one embodiment of processors 302a and 302b (such as discussed below with reference to FIG. 9), socket-to-socket interconnect 802 is connected to a ring interconnect on each processor that is also coupled to iMCs 306 and 308 on each socket. The interconnects may be configured to operate while the processor cores are in reduced power states, enabling data to be transferred from DRAM DIMMs on node A to persistent storage device 330b on node B. Since a DMA engine can operate independent of a processor's cores, the processor cores on processor 302b can also be in a reduced power state.

Under system 800b, DRAM data is restored in a similar manner to described in flowchart 600 for node B, while the DRAM data that is restored for node A is passed from node B to node A via socket-to-socket interconnect 802. In one embodiment, the persistent storage device used to store the DRAM data includes separate provisions for each of nodes A and B. For example, persistent storage device 330b may include separate partitions to store DRAM data for nodes A and B. In addition, data relating to memory configurations (e.g., SPA data, ACPI tables, credentials, various meta-data, etc.) for each of nodes A and B will also be stored in persistent storage device 330b, or otherwise will be stored on system 800b in a manner under which it is accessible during the DRAM copy and restore operations.

Further details of one embodiment of a multi-socket system 900 is shown in FIG. 9. System 900 is illustrative of an advanced system architecture including SoC processors supporting multiple processor cores 202, each coupled to a respective node 204 on a ring interconnect, labeled and referred to herein as Ring2 and Ring3 (corresponding to processors installed in processors sockets 2 and 3, respectfully of a 4-socket platform). For simplicity, the nodes for each of the Ring3 and Ring2 interconnects are shown being connected with a single line. As shown in detail 906, in one embodiment each of these ring interconnects include four separate sets of “wires” or electronic paths connecting each node, thus forming four rings for each of Rng2 and Ring3. In actual practice, there are multiple physical electronic paths corresponding to each wire that is illustrated. It will be understood by those skilled in the art that the use of a single line to show connections herein is for simplicity and clarity, as each particular connection may employ one or more electronic paths.

In the context of system 900, a cache coherency scheme may be implemented by using independent message classes. Under one embodiment of a ring interconnect architecture, independent message classes may be implemented by employing respective wires for each message class. For example, in the aforementioned embodiment, each of Ring2 and Ring3 include four ring paths or wires, labeled and referred to herein as AD, AK, IV, and BL. Accordingly, since the messages are sent over separate physical interconnect paths, they are independent of one another from a transmission point of view.

In one embodiment, data is passed between nodes in a cyclical manner. For example, for each real or logical clock cycle (which may span one or more actual real clock cycles), data is advanced from one node to an adjacent node in the ring. In one embodiment, various signals and data may travel in both a clockwise and counterclockwise direction around the ring. In general, the nodes in Ring2 and Ring 3 may comprise buffered or unbuffered nodes. In one embodiment, at least some of the nodes in Ring2 and Ring3 are unbuffered.

Each of Ring2 and Ring3 include a plurality of nodes 904. Each node labeled Cbo n (where n is a number) is a node corresponding to a processor core sharing the same number n (as identified by the core's engine number n). There are also other types of nodes shown in system 900 including QPI nodes 3-0, 3-1, 2-0, and 2-1, an IIO node, and PCIe nodes. Each of QPI nodes 3-0, 3-1, 2-0, and 2-1 is operatively coupled to a respective QPI Agent 3-0, 3-1, 2-0, and 2-1. The IIO node is operatively coupled to an IIO interface 310. Similarly, PCIe nodes are operatively coupled to PCIe interfaces 912 and 914. Further shown are a number of nodes marked with an “X”; these nodes are used for timing purposes. It is noted that the QPI, IIO, PCIe and X nodes are merely exemplary of one implementation architecture, whereas other architectures may have more or less of each type of node or none at all. Moreover, other types of nodes (not shown) may also be implemented. In some embodiments (such as shown in various Figures herein), an IIO interface will include one or more PCIe interfaces.

Each of the QPI agents 3-0, 3-1, 2-0, and 2-1 includes circuitry and logic for facilitating transfer of QPI packets between the QPI agents and the QPI nodes they are coupled to. This circuitry includes ingress and egress buffers, which are depicted as ingress buffers 916, 918, 920, and 922, and egress buffers 924, 926, 928, and 930.

System 900 also shows two additional QPI Agents 1-0 and 1-1, each corresponding to QPI nodes on rings of CPU sockets 0 and 1 (both rings and nodes not shown). As before, each QPI agent includes an ingress and egress buffer, shown as ingress buffers 932 and 934, and egress buffers 936 and 938.

In the context of maintaining cache coherence in a multi-processor (or multi-core) environment, various mechanisms are employed to assure that data does not get corrupted. For example, in system 900, each of processor cores 902 corresponding to a given CPU is provided access to a shared memory store associated with that socket, which typically will comprise one or more banks of DRAM packaged as DIMMs or SIMMs. As discussed above, the DRAM DIMMs for a system is accessed via one or more memory controllers, such as depicted by a memory controller 0 and memory controller 1, which are shown respectively connected to a home agent node 0 (HA 0) and a home agent node 1 (HA 1).

As each of the processor cores executes its respective code, various memory accesses will be performed. As is well known, modern processors employ one or more levels of memory cache to store cached memory lines closer to the core, thus enabling faster access to such memory. However, this entails copying memory from the shared (i.e., main) memory store to a local cache, meaning multiple copies of the same memory line may be present in the system. To maintain memory integrity, a cache coherency protocol is employed, such as MESI (Mutual, Exclusive, Shared, Invalid) or MESIF (Mutual, Exclusive, Shared, Invalid, Forwarded)

It is also common to have multiple levels of caches, with caches closest to the processor core having the least latency and smallest size, and the caches further away being larger but having more latency. For example, a typical configuration might employ first and second level caches, commonly referred to as L1 and L2 caches. Another common configuration may further employ a third level or L3 cache.

In the context of system 900, the highest level cache is termed the Last Level Cache, or LLC. For example, the LLC for a given core may typically comprise an L3-type cache if L1 and L2 caches are also employed, or an L2-type cache if the only other cache is an L1 cache. Of course, this could be extended to further levels of cache, with the LLC corresponding to the last (i.e., highest) level of cache.

In the illustrated configuration of FIG. 9, each processor core 902 includes a processing engine 942 coupled to an L1 or L1/L2 cache 944, which are “private” to that core. Meanwhile, each processor core is also co-located with a “slice” of a distributed LLC 946, wherein each of the other cores has access to all of the distributed slices. Under one embodiment, the distributed LLC is physically distributed among N cores using N blocks divided by corresponding address ranges. Under this distribution scheme, all N cores communicate with all N LLC slices, using an address hash to find the “home” slice for any given address. Suitable interconnect circuitry is employed for facilitating communication between the cores and the slices; however, such circuitry is not show in FIG. 9 for simplicity and clarity.

As further illustrated, each of nodes 904 in system 900 associated with a processor core 902 is also associated with a cache agent 948, which is configured to perform messaging relating to signal and data initiation and reception in connection with a coherent cache protocol implemented by the system, wherein each cache agent 948 handles cache-related operations corresponding to addresses mapped to its collocated LLC 946. In addition, in one embodiment each of home agents HA0 and HA1 employ respective cache filters 950 and 952, and the various caching and home agents access and update cache line usage data stored in a respective directories that are implemented in a portion of the shared memory (not shown). It will be recognized by those skilled in the art that other techniques may be used for maintaining information pertaining to cache line usage.

In accordance with one embodiment, a single QPI node may be implemented to interface to a pair of socket-to-socket QPI links to facilitate a pair of QPI links to adjacent sockets. This is logically shown in FIG. 9 and other drawings herein by dashed ellipses that encompass a pair of QPI nodes within the same socket, indicating that the pair of nodes may be implemented as a single node.

Under some embodiments, during DRAM copy and restore operations discussed above with reference to flowcharts 600 and 700, various memory access and cache access operations are performed to first flush the cached memory in the L1/L2 and LLC caches (as applicable) to DRAM, DRAM data marked as persistent is copied to a persistent storage device, and subsequently the persistent DRAM data is restored back to DRAM. Depending on the particular implementation (e.g., a DMA engine-based scheme, an SMI/SMM handler scheme, etc.), various components on the processors will be provided with power under the control of APIC 506 and/or PCU 508.

In one embodiment, memory transactions are facilitated using corresponding message classes including messages that are forwarded between nodes and across QPI links (as applicable), enabling various agents to access and forward data stored in DRAM (or a cache level) to other agents. This enables one or more agents on a “local” socket to access data in memory on a “remote” socket. For example, in the context of system 800b, node B is a local socket and node A is a remote sockets. Thus, an agent on node B can send a message to an agent (e.g., a home agent) on node A requesting access to data in DRAM accessed via a memory controller on node B. In response, the agent will retrieve the requested data and return it via one or more messages to the requesting agent. Under the context of system 800b, the rings in the processors in system 900 are power protected and thus enabled to transfer messages (including the data contained in the messages) when the platform's primary power source is unavailable.

FIG. 10 illustrates a system 1000 that employs an SMI and System Management Mode (SMM) to copy data to persistent storage device 330 in response to detection of a power failure or power source removal event. As described above, in one embodiment SMI is used to flush data in the processor cache(s) to DRAM prior to performing the persistent DRAM data copy. If sufficient power is available from the super capacitor, in one embodiment the DRAM copy operation is effected via SMM using one of the processor cores.

SMI and SMM operate in the following manner. In response to an SMI interrupt, the processor stores its current context (i.e., information pertaining to current operations, including its current execution mode, stack and register information, etc.), and switches its execution mode to its SMM. SMM handlers are then sequentially dispatched to determine if they are the appropriate handler for servicing the SMI event. This determination is made very early in the SMM handler code, such that there is little latency in determining which handler is appropriate. When this handler is identified, it is allowed to execute to completion to service the SMI event. After the SMI event is serviced, an RSM (resume) instruction is issued to return the processor to its previous execution mode using the previously saved context data. The net result is that SMM operation is completely transparent to the operating system.

In one embodiment, in addition to flushing cache data to DRAM, one or more SMM handlers are configured to copy DRAM data in one or more of DRAM DIMMs 314, 316, 322, and 324 to persistent storage device 300 in response to an SMI, which in turn is invoked in response to detection of a power failure/power source removal event. Under system 1000, in response to the power failure/power source removal event, power is supplied (via super capacitor 338 and power conditioning circuitry 336) to a core 1002 in CPU 304 on which the one or more SMM handlers are executed. Generally, core 1002 may copy DRAM data to persistent storage device using conventional data transfer techniques under which data is transferred from a system memory resource to a storage resource in a manner that does not employ DMA engine 312. Optionally, various data transfer operations may be off-loaded to the DMA engine, in which case power would also be provided to the DMA engine (not shown).

In addition to automatically copying DRAM data to persistent storage in response to power failure/removal events, embodiments may be configure to perform similar operations in response to operating system error or failure events. For example, in conjunction with a failure to a Microsoft Windows operating system, a “Blue Screen” or a “Blue Screen of Death” (BSOD) event occurs under which the Windows graphical interface is replaced with a blue screen with text indicating a failure condition. Under some failure conditions, enough of the operating system is still accessible to enable the surviving portion to dump the memory contents to storage (typically to a large log or debug file). Generally, the memory contents that are dumped cannot be used to restore the system state before the BSOD event. Under some BSOD events, the operating system may only write out a small amount of data.

Under one or more embodiments, that platform hardware and/or firmware is configured to detect BSOD events, and copy applicable DRAM data to a persistent storage device in a manner similar to that described herein in response to a power failure or power source removal event. In one embodiment, the DRAM data copy operation and associated data transfer is performed using a DMA engine. In another embodiment, the DRAM data copy operation is performed using an SMI and one or more associated SMM handlers.

In one embodiment, the operations shown in a flowchart 701 of FIG. 7a are performed. The process begins in a start block 703 with detection of an operating system error or failure event, such as a BSOD. In response, the operations depicted in blocks 704, 706, 708, 710, 712, and 714 are performed in a manner similar to that described above with reference to flowchart 700 of FIG. 7.

The embodiments of the solutions proposed herein provide several advantageous over the existing NVDIMM solution to data persistence across power failures/shutdowns. Notably, the proposed solution. As discussed above, the NVDIMM sizes available today contains about half of DRAM capacity (they could have) due to NAND & FPGA real-estate usage, hence the overall OS visible memory capacity is reduced to half with the existing NVDIMM approach, resulting in reduced workload performance. In accordance with the embodiments, standard DRAM DIMMS are used rather than NVDIMMs, hence the OS visible persistent memory size is the same as the DRAM size, thus overall memory available to workload is not reduced as compared to DRAM.

The proposed solution has a much lower total cost of ownership. The existing NVDIMM solutions costs 3× to 4× of DRAM on a per-memory unit basis (e.g., per GigaByte of memory). The cost for persistent DRAM using the proposed solution is the DRAM cost plus the SSD cost (assuming the processor supports the power fail copy from DRAM to SSD feature). The cost of an SSD is much less (approximately 1/10) than DRAM for the same capacity. Hence the overall cost of persistent DRAM memory using the proposed invention is approximately 1.2× the cost of DRAM alone (assuming a double to DRAM capacity SSD provision).

Another advantage is reduced validation cost. This proposed solution supports the use standard DRAM DIMMs and SSDs in the platform. Hence no additional DIMM validation or qualification validation is required as compared to additional work for Memory Reference Code (MRC) to support NVDIMMs and additional validation and qualifications for NVDIMMs.

The proposed solution provides a lower service cost. As discussed above, it enables use of conventional DRAM DIMMs and SSD, rather than much more expensive NVDIMMs. This supports simply replacing DRAM DIMMs when a DRAM DIMM fails. In existing NVDIMMs, if a single NVDIMM fails, if the data are interleaved across multiple DIMMs, then all the data are not recoverable. Conversely, under embodiments herein, if a failing DRAM device is identified during boot, the user can replace the DRAM device with a new DRAM device and then restore the DRAM data from SSD to the DRAM device.

It also enables replication of a stored memory configuration on another platform (such as a replacement platform), without requiring the rigid 1:1 NVDIMM configurations (used to store the DRAM data) in the replacement platform. In existing NVDIMMs, the NVDIMMs has to be moved and populated with the same interleave order. For example, if three NVDIMMs are interleaved, if the NVDIMMs are moved from one to another, all the NVDIMMs need to be moved and populated on the same position and configured for the same interleave. Under the disclosed solutions, if DRAM data from three DIMMs are interleaved and data stored in the SSD, the SSD could be moved to another system with a configuration including one DRAM DIMM or two DRAM DIMMs, as long as enough DRAM capacity is available.

The proposed solution also provides additional advantages. For example, under various embodiments, the entire DRAM is written to persistent storage, or alternately, a selected portion of the DRAM is written to persistent storage. Existing NVDIMMs provide only an ALL size or NONE size persistent capability.

The DRAM data can also be written using a protected persistent storage scheme (data at rest protection), where existing NVDIMMs does not provide security features. Under the embodiments disclosed herein, security measures used for storing data on SSDs (or other persistent storage devices) can be applied for storing the DRAM data.

RAID support may also be implemented during save/restore operations. For example, the storage device subsystem can have a RAID configuration, where the DRAM data could be stored using various RAID-based storage schemes, including mirrored and striped storage schemes to provide additional data storage reliability.

One or more embodiments may be configured to make high speed memory such as MCDRAM (high speed multi-channel DRAM) persistent. Currently there is no NVDIMM solution available for making MCDRAM persistent. Under the schemes described herein, an MCDRAM area of system DRAM can be stored to the SSD during power failure if the MCDRAM is power protected.

Further aspects of the subject matter described herein are set out in the following numbered clauses:

1. A method for saving data in dynamic random access memory (DRAM) in a computer platform to a persistent storage device, wherein the computer platform includes a primary power source used to provide power to components in the computer platform during normal operation, the computer platform including the persistent storage device and running an operating system during normal operation, the method comprising:

detecting a power unavailable condition under which power is no longer being supplied by the primary power source to the computer platform; and, in response to detection of the power unavailable condition,

automatically copying data in the DRAM to the persistent storage device without operating system intervention.

2. The method of clause 1, wherein the computer platform includes a processor including a plurality of caches, the method further comprising flushing data in the caches to DRAM prior to copying the data in the DRAM to the persistent storage device.

3. The method of clause 1 or 2, further comprising:

defining at least one region of the DRAM address space to comprise persistent DRAM;

configuring a persistent storage area on the persistent storage device in which the data in the persistent DRAM is to be stored; and

storing the data copied from the persistent DRAM to the persistent storage area.

4. The method of any of the preceding clauses, wherein the computer platform includes a power protected direct memory access (DMA) engine, the method further comprising programming the power protected DMA engine to copy data in the DRAM to the persistent storage device.

5. The method of any of the preceding clauses, wherein the computer platform further comprises:

a processor including,

at least one memory controller including a first memory controller; and

an input-output (IO) interface including a Direct Memory Access (DMA) engine;

at least one DRAM device in which data to be saved is stored prior to the power unavailable condition, operatively coupled to the first memory controller via a first memory controller-to-DRAM device link; and

an IO link coupling the persistent storage device to the IO interface,

wherein the method further comprises providing temporary power to a plurality of power protected components in the computer platform in response to detection of the power unavailable condition, wherein the plurality of power protected components include the first memory controller, the DMA engine, the at least one DRAM device, the first memory controller-to-DRAM device link, the IO link coupling the persistent storage device to the IO interface, and the persistent storage device.

6. The method of clause 5, wherein the temporary power is provided via a capacitor-based power circuit.

7. The method of clause 5, wherein the temporary power is provided via a battery.

8. The method of clause 5, wherein the temporary power is provided via a combination of a capacitor-based power circuit and a battery.

9. The method of any of the preceding clauses, further comprising:

determining, during a platform initialization operation, whether the persistent storage device is storing any DRAM data that was previously copied from DRAM to the persistent storage device in response to a power unavailable condition; and

restoring the DRAM data to one or more DRAM devices from which the DRAM data was copied.

10. The method of clause 9, wherein the DRAM data is stored in a scrambled format before being copied to the persistent storage device, and the DRAM data is restored using a non-scrambled format.

11. The method of clause 10, wherein the DRAM data is stored in memory that includes error correction codes, and the DRAM data that is copied to the persistent storage device include data identifying uncorrected error conditions.

12. The method of method of clause 1, wherein automatically copying data in the DRAM to the persistent storage device without operating system intervention is implemented through the use of a System Management Interrupt (SMI) and one or more System Management Mode (SMM) handlers, wherein in response to detection of the power unavailable condition an SMI is invoked that dispatches the one or more SMM handlers to service the SMI by copying the DRAM data to the persistent storage device.

13. A computing platform having a primary power source, comprising:

a processor including,

at least one memory controller including a first memory controller; and

an input-output (IO) interface including a Direct Memory Access (DMA) engine;

at least one dynamic random access memory (DRAM) device including a first DRAM device, operatively coupled to the first memory controller via a first memory controller-to-DRAM device link;

a persistent storage device, operatively coupled to the IO interface via an IO link; and

a temporary power source, operatively coupled to each of the first memory controller, the persistent storage device, the IO link, the first DRAM device, and the first memory controller-to-DRAM device link, wherein the temporary power source is configured to supply power to each of the first memory controller, the persistent storage device, the IO link, the first DRAM device, and the first memory controller-to-DRAM device link for a finite period of time in the event of a condition under which the primary power source no longer supplies power to the computer platform;

wherein the computer platform is configured to detect a condition under which the primary power source no longer supplies power to the computer platform and wherein in response to detection of the condition the IO interface is configured to copy data stored in the first DRAM to the persistent storage device via the DMA engine.

14. The computer platform of clause 13, wherein the compute platform is further configured to restore data that has previously been copied from the first DRAM device to the persistent storage device during a platform initialization operation performed by copying data from the persistent storage device to the first DRAM device via the DMA engine.

15. The compute platform of clause 13 or 14, wherein the compute platform includes a plurality of DRAM devices comprising DRAM dual in-line memory modules (DIMMs), each coupled to a memory controller via a memory controller-to-DRAM DIMM link, wherein the temporary power source is configured to supply power to each of the plurality of DRAM DIMMs, each memory controller, and each memory controller-to-DRAM DIMM link in the event of a condition under which the primary power source no longer supplies power to the computer platform; and wherein in response to detection of the condition under which the primary power source no longer supplies power to the computer platform the IO interface is configured to copy data stored on each of the plurality of DRAM DIMMs to the persistent storage device via the DMA engine.

16. The compute platform of clause 15, wherein the processor includes at least two memory controllers, each memory controller coupled to at least two DRAM DIMMs.

17. The computer platform of clause 15, wherein the compute platform is further configured to restore data that has previously been copied from each of the plurality of DRAM DIMMS to the persistent storage device during a platform initialization operation performed by copying the previously copied data from the persistent storage device to each of the DRAM DIMMs via the DMA engine, wherein, upon restoration of the data each DRAM DIMM stores the same data that it was storing prior to the occurrence of the condition under which the primary power source no longer was supplying power to the computer platform.

18. The computer platform of any of clauses 13-17, wherein the IO link comprises a Peripheral Control Interconnect Express (PCIe) link.

19. The computer platform of any of clauses 13-18, wherein the persistent storage device comprises a solid-state drive (SSD).

20. The computer platform of any of clauses 13-19, wherein the processor includes at least one processor cache, and manages a write-pending queue, and wherein in response to detection of the unavailable power condition, data in the at least one processor cache and the write-pending queue is flushed to the first DRAM device prior to copying the data from the first DRAM device to the persistent storage device.

21. The computer platform of any of clauses 13-20, wherein the processor includes a central processor unit (CPU) with a plurality of cores, and the IO interface is coupled to a plurality of IO links, and wherein in response to detect of the unavailable power condition the processor enters a power down state where all of the IO links except the power protected links have their power reduced, and the cores are operated in a reduced power state.

22. The computer platform of any of clauses 13-20, wherein upon completion of copying the data from the DRAM device to the persistent storage device, meta-data stored in the persistent storage device is updated to indicate the data has been successfully saved to the persistent storage device.

23. The computer platform of any of clauses 13-22, wherein the temporary power source is a capacitor-based power circuit.

24. The computer platform of any of clauses 13-23, wherein the temporary power source is a battery.

25. The computer platform of any of clauses 13-24, wherein the temporary power source comprises a combination of a capacitor-based power circuit and a battery.

26. The computer platform of any of clauses 13-25, wherein the at least one memory controller further includes a second memory controller to which a second DRAM device is operatively coupled via a second memory controller-to-DRAM device link, and wherein the temporary power source is further operatively coupled to the second memory controller and the second DRAM device, and wherein the IO interface is further configured to copy data stored in the second DRAM device to the persistent storage device via the DMA engine.

27. The computer platform of any of clauses 13-25, wherein the at least one DRAM device includes a second DRAM device operatively coupled to the first memory controller via a second memory controller-to-DRAM device link, and wherein the IO interface is further configured to copy data stored in the second DRAM device to the persistent storage device via the DMA engine.

28. The computer platform of clause 13, wherein the computer platform further includes logic configured to:

determine, during a platform initialization operation, whether the persistent storage device is storing any DRAM data that was previously copied from DRAM to the persistent storage device in response to a power unavailable condition; and

restore the DRAM data to one or more DRAM devices from which the DRAM data was copied.

29. The computer platform of clause 28, wherein the DRAM data is stored in a scrambled format before being copied to the persistent storage device, and the DRAM data is restored using a non-scrambled format.

30. A processor, configured to be installed in a computer platform including a power supply having a primary power input source, one or more dynamic random access memory (DRAM) devices, and a persistent storage device, the processor comprising:

a plurality of processor cores, operatively coupled to an interconnect;

at least one memory controller including a first memory controller and memory controller interface, operatively coupled to the interconnect and configured to interface with a first memory controller-to-DRAM device link coupled at an opposing end to a first DRAM device when the processor is installed in the computer platform;

an input-output (IO) interface, operatively coupled to the interconnect and including a link interface for an IO link to which the persistent storage device is coupled;

a Direct Memory Access (DMA) engine; and

logic, configured upon operation of the processor to,

detect a power unavailable condition under which the primary power input source no longer supplies power to the power supply; and in response to detection of the condition, copy DRAM data stored in the first DRAM device to the persistent storage device.

31. The processor of clause 30, further comprising a Direct Memory Access (DMA) engine, and wherein the DRAM data stored in the first DRAM device is copied to the persistent storage device via the DMA engine.

32. The processor of clause 30, wherein the processor is configured to implement a System Management Interrupt (SMI) and to operate in a System Management Mode (SMM), and further wherein the processor is configured, upon operation and in response to the power unavailable condition, to invoke an SMI and dispatch one or more SMM handlers to service the SMI by copying the DRAM data stored in the first DRAM device to the persistent storage device.

33. The processor of any of clauses 30-32, wherein the processor further comprises at least one of a APIC (Advance Programmable Interrupt Controller) logic block and a power control unit (PCU), and in response to the detection of the condition at least one of the APIC logic block and the PCU is configured to provide power to selected components in the processor to enable the DRAM data to be copied to the persistent storage device, while reducing power to other components on the processor that are not employed to facilitate transfer of data to the persistent storage device via the DRAM data copy.

34. The processor of any of clauses 30-33, wherein the compute platform comprises a multi-socket platform having a plurality of sockets and including a first socket comprising a local socket and a second socket comprising a remote socket and a socket-to-socket interconnect between the first and second sockets, wherein the processor is configured to have respective instances of the processor installed in respective local and remote sockets, and wherein the processor further comprises a socket-to-socket interconnect interface configured to couple to the socket-to-socket interconnect, and further wherein the processor includes logic configured, in response to detection of the power unavailable condition and when the processor is installed in a local socket, to:

copy data from one or more DRAM devices accessed via one or more memory controllers on the processor to the persistent storage device; and

interface with the processor in the remote socket to copy data from one or more DRAM devices accessed via one or more memory controllers on the processor installed in the remote socket to the persistent storage device.

35. The processor of any of clauses 30-34, wherein upon completion of copying the data from the first DRAM device to the persistent storage device, the processor is configured to send data over the IO link to update meta-data stored in the persistent storage device to indicate the data has been successfully saved to the persistent storage device.

36. The processor of any of clauses 30-33, wherein the first memory controller and memory controller interface is configured to interface with a second memory controller-to-DRAM device link coupled at an opposing end to a second DRAM device when the processor is installed in the computer platform, and wherein the logic if further configured, upon operation of the processor and in response to detection of the power unavailable condition, to copy DRAM data stored in the second DRAM device to the persistent storage device.

37. The processor of any of clauses 30-33, wherein the at least one memory controller includes a second memory controller and second memory controller interface configured to interface with a second memory controller-to-DRAM device link coupled at an opposing end to a second DRAM device when the processor is installed in the computer platform, and wherein the logic is further configured, upon operation of the processor and in response to detection of the power unavailable condition, to copy DRAM data stored in the second DRAM device to the persistent storage device.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or embedded logic or the like. Thus, embodiments of this invention may be used as or to support a software program, software modules, and/or firmware executed upon some form of processor, processing core or embedded logic or a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for saving data in dynamic random access memory (DRAM) in a computer platform to a persistent storage device, wherein the computer platform includes a primary power source used to provide power to components in the computer platform during normal operation, the computer platform including the persistent storage device and running an operating system during normal operation, the method comprising:
detecting a power unavailable condition under which power is no longer being supplied by the primary power source to the computer platform; and, in response to detection of the power unavailable condition,
automatically copying data in the DRAM to the persistent storage device without operating system intervention.

2. The method of claim 1, wherein the computer platform includes a processor including a plurality of caches, the method further comprising flushing data in the caches to DRAM prior to copying the data in the DRAM to the persistent storage device.

3. The method of claim 1, further comprising:
defining at least one region of the DRAM address space to comprise persistent DRAM;
configuring a persistent storage area on the persistent storage device in which the data in the persistent DRAM is to be stored; and
storing the data copied from the persistent DRAM to the persistent storage area.

4. The method of claim 1, wherein the computer platform includes a power protected direct memory access (DMA) engine, the method further comprising programming the power protected DMA engine to copy data in the DRAM to the persistent storage device.

5. The method of claim 1, wherein the computer platform further comprises:
a processor including,
at least one memory controller including a first memory controller; and
an input-output (IO) interface including a Direct Memory Access (DMA) engine;
at least one DRAM device in which data to be saved is stored prior to the power unavailable condition, operatively coupled to the first memory controller via a first memory controller-to-DRAM device link; and
an IO link coupling the persistent storage device to the IO interface,
wherein the method further comprises providing temporary power to a plurality of power protected components in the computer platform in response to detection of the power unavailable condition, wherein the plurality of power protected components include the first memory controller, the DMA engine, the at least one DRAM device, the first memory controller-to-DRAM device link, the IO link coupling the persistent storage device to the IO interface, and the persistent storage device.

6. The method of claim 5, wherein the temporary power is provided via a capacitor-based power circuit.

7. The method of claim 1, further comprising:
determining, during a platform initialization operation, whether the persistent storage device is storing any DRAM data that was previously copied from DRAM to the persistent storage device in response to a power unavailable condition; and
restoring the DRAM data to one or more DRAM devices from which the DRAM data was copied.

8. The method of claim 7, wherein the DRAM data is stored in a scrambled format before being copied to the persistent storage device, and the DRAM data is restored using a non-scrambled format.

9. The method of claim 1, wherein automatically copying data in the DRAM to the persistent storage device without operating system intervention is implemented through the use of a System Management Interrupt (SMI) and one or more System Management Mode (SMM) handlers, wherein in response to detection of the power unavailable condition an SMI is invoked that dispatches the one or more SMM handlers to service the SMI by copying the DRAM data to the persistent storage device.

10. A computing platform having a primary power source, comprising:
a processor including,
at least one memory controller including a first memory controller; and
an input-output (IO) interface including a Direct Memory Access (DMA) engine;
at least one dynamic random access memory (DRAM) device including a first DRAM device, operatively coupled to the first memory controller via a first memory controller-to-DRAM device link;
a persistent storage device, operatively coupled to the IO interface via an IO link; and
a temporary power source, operatively coupled to each of the first memory controller, the persistent storage device, the IO link, the first DRAM device, and the first memory controller-to-DRAM device link, wherein the temporary power source is configured to supply power to each of the first memory controller, the persistent storage device, the IO link, the first DRAM device, and the first memory controller-to-DRAM device link for a finite period of time in the event of a condition under which the primary power source no longer supplies power to the computer platform;
wherein the computer platform is configured to detect a condition under which the primary power source no longer supplies power to the computer platform and wherein in response to detection of the condition the IO interface is configured to copy data stored in the first DRAM to the persistent storage device via the DMA engine.

11. The computer platform of claim 10, wherein the compute platform is further configured to restore data that has previously been copied from the first DRAM device to the persistent storage device during a platform initialization operation performed by copying data from the persistent storage device to the first DRAM device via the DMA engine.

12. The compute platform of claim 10, wherein the compute platform includes a plurality of DRAM devices comprising DRAM dual in-line memory modules (DIMMs), each coupled to a memory controller via a memory controller-to-DRAM DIMM link, wherein the temporary power source is configured to supply power to each of the plurality of DRAM DIMMs, each memory controller, and each memory controller-to-DRAM DIMM link in the event of a condition under which the primary power source no longer supplies power to the computer platform; and wherein in response to detection of the condition under which the primary power source no longer supplies power to the computer platform the IO interface is configured to copy data stored on each of the plurality of DRAM DIMMs to the persistent storage device via the DMA engine.

13. The compute platform of claim 12, wherein the processor includes at least two memory controllers, each memory controller coupled to at least two DRAM DIMMs.

14. The computer platform of claim 12, wherein the compute platform is further configured to restore data that has previously been copied from each of the plurality of DRAM DIMMS to the persistent storage device during a platform initialization operation performed by copying the previously copied data from the persistent storage device to each of the DRAM DIMMs via the DMA engine, wherein, upon restoration of the data each DRAM DIMM stores the same data that it was storing prior to the occurrence of the condition under which the primary power source no longer was supplying power to the computer platform.

15. The computer platform of claim 10, wherein the IO link comprises a Peripheral Control Interconnect Express (PCIe) link.

16. The computer platform of claim 10, wherein the persistent storage device comprises a solid-state drive (SSD).

17. The computer platform of claim 10, wherein the processor includes at least one processor cache, and manages a write-pending queue, and wherein in response to detection of the unavailable power condition, data in the at least one processor cache and the write-pending queue is flushed to the first DRAM device prior to copying the data from the first DRAM device to the persistent storage device.

18. The computer platform of claim 10, wherein the processor includes a central processor unit (CPU) with a plurality of cores, and the IO interface is coupled to a plurality of IO links, and wherein in response to detect of the unavailable power condition the processor enters a power down state where all of the IO links except the power protected links have their power reduced, and the cores are operated in a reduced power state.

19. The computer platform of claim 10, wherein upon completion of copying the data from the DRAM device to the persistent storage device, meta-data stored in the persistent storage device is updated to indicate the data has been successfully saved to the persistent storage device.

20. A processor, configured to be installed in a computer platform including a power supply having a primary power input source, one or more dynamic random access memory (DRAM) devices, and a persistent storage device, the processor comprising:
a plurality of processor cores, operatively coupled to an interconnect;
at least one memory controller including a first memory controller and memory controller interface, operatively coupled to the interconnect and configured to interface with a first memory controller to DRAM device link coupled at an opposing end to a first DRAM device when the processor is installed in the computer platform;
an input-output (IO) interface, operatively coupled to the interconnect and including a link interface for an IO link to which the persistent storage device is coupled;
a Direct Memory Access (DMA) engine; and
logic, configured upon operation of the processor to,
detect a power unavailable condition under which the primary power input source no longer supplies power to the power supply; and in response to detection of the condition,
copy DRAM data stored in the first DRAM device to the persistent storage device.

21. The processor of claim 20, further comprising a Direct Memory Access (DMA) engine, and wherein the DRAM data stored in the first DRAM device is copied to the persistent storage device via the DMA engine.

22. The processor of claim 20, wherein the processor is configured to implement a System Management Interrupt (SMI) and to operate in a System Management Mode (SMM), and further wherein the processor is configured, upon operation and in response to the power unavailable condition, to invoke an SMI and dispatch one or more SMM handlers to service the SMI by copying the DRAM data stored in the first DRAM device to the persistent storage device.

23. The processor of claim 20, wherein the processor further comprises at least one of a APIC (Advance Programmable Interrupt Controller) logic block and a power control unit (PCU), and in response to the detection of the condition at least one of the APIC logic block and the PCU is configured to provide power to selected components in the processor to enable the DRAM data to be copied to the persistent storage device, while reducing power to other components on the processor that are not employed to facilitate transfer of data to the persistent storage device via the DRAM data copy.

24. The processor of claim 20, wherein the compute platform comprises a multi-socket platform having a plurality of sockets and including a first socket comprising a local socket and a second socket comprising a remote socket and a socket-to-socket interconnect between the first and second sockets, wherein the processor is configured to have respective instances of the processor installed in respective local and remote sockets, and wherein the processor further comprises a socket-to-socket interconnect interface configured to couple to the socket-to-socket interconnect, and further wherein the processor includes logic configured, in response to detection of the power unavailable condition and when the processor is installed in a local socket, to:
copy data from one or more DRAM devices accessed via one or more memory controllers on the processor to the persistent storage device; and
interface with the processor in the remote socket to copy data from one or more DRAM devices accessed via one or more memory controllers on the processor installed in the remote socket to the persistent storage device.

25. The processor of claim 20, wherein upon completion of copying the data from the first DRAM device to the persistent storage device, the processor is configured to send data over the IO link to update meta-data stored in the persistent storage device to indicate the data has been successfully saved to the persistent storage device.
